(19) United States
(12) Patent Application Publication
(10) Pub. No.: US 2007/0261279 A1
(43) Pub. Date: Nov. 15, 2007

(54) Personal emergency information system

(76) Inventor: Martha Horton Wolfe, Rogersville, TN (US)

Correspondence Address: MARTHA H. WOLFE, 488 CANEY CREEK RD, ROBERSVILLE, TN, 37857, US

(21) Appl. No.: 11/430,141

(22) Filed: May 9, 2006

(51) Int. Cl. G09F 3/10; G06F 17/00; G08B 13/14

(52) U.S. Cl. 40/299.01; 340/572.8; 235/375

(57) ABSTRACT

A two part system to notify emergency first responders how to find personal emergency medical information and to provide that information The system maintains security of personal information until needed.

### CROSS-REFERENCE TO RELATED APPLICATIONS

Not applicable

### FEDERALLY SPONSORED RESEARCH OR DEVELOPMENT

Not applicable

### BACKGROUND OF THE INVENTION

1. Field of the Invention

This invention relates to a system of allowing access to personal emergency information only to accident first responders.

2. Description of Prior Art

Various systems have been proposed to communicate emergency personal and medical information to first responders in case of accidents. U.S. Pat. Nos. 919,983 and 1,255,870, and 4,984,683 jewelry were proposed to hold medicines and convey information. In U.S. Pat. No. 6,155,409 Hettinger teaches personal emergency information can be made available in a locket or pocket watch. U.S. Pat. No. 4,078,660 teaches the use of a medic alert bracelet. These devices have limited information storage capability and first responders do not know to look for the items.

In U.S. Pat. No. 5,848,700 Horn teaches the use of a briefcase-sized medical kit to convey general information. The medical kit may not be present or obvious at an automobile accident site.

U.S. Pat. D 380,234 teaches an emergency home placard. The single placard does not always alert rescue personal, is subject to easy unintentional removal, and personal information is not protected from unauthorized viewing. In U.S. Pat. No. 5,215,334 Presson teaches an emergency medical card with reduced format text and a magnifying lens. Again, emergency personnel would not know where to look for such at the time of an accident.

### BRIEF SUMMARY OF THE INVENTION

This present invention is a system of decals that alert and inform emergency rescue and medical personnel in case of an accident. The alert decals, characterized by the presence of a easily seen caduceus, informs personnel that personal information will be present at a specific site in the vehicle or building. A second decal contains needed personal and emergency medical information about specific persons described by physical description or photograph. The second decal is located and so constructed that the information is not available to casual observation.

### BRIEF DESCRIPTION OF THE DRAWINGS:

Not applicable.

### DETAILED DESCRIPTION OF THE INVENTION

While this invention may have many different forms, the present disclosure is to be considered as an exemplification of the principles of the invention and is not intended to limit the invention to the specific embodiments illustrated.

A two tier notification system is provided to accomplish notification of appropriate personal, yet retain confidentiality of sensitive personal information. One or more decals, attached as appropriate in a removable, semi-permanent, or permanent manner contain alerting symbols, such as a caduceus and other symbols, are to be prominently displayed in at least one window of an automobile, truck, or other vehicle or building. These are the alert decals. The alert decals are of such size as to be readily noticed and yet remain lawful. The alert decals instruct the emergency responder personnel that specific information is located at a specific location in the vehicle or building.

An additional decal, attached as appropriate in a removable, semi-permanent, or permanent manner, is the information decal and can be located in any easily accessible area of the occupied compartment of the vehicle or building. In particular, a decal could be placed or attached to the surface of the driver's visor such that the information would not be noticed or easily read when the visor is in its normal stored position.

The information decal would have sections to identify individuals by race, sex, and approximate age prominently displayed. Personal information such as medical conditions, drug allergies, and medications being used could be added. Contact information could also be listed. Other important information could be added including, but not limited to, photographs, encoded microchips, holograms, or other information transmission media. At a minimum, information would be hand written on the information decal.

The information decal may have a sleeve or other cover to further protect confidentiality.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

I claim:

1. A system of decals or stickers to communicate personal emergency information to appropriate first responder personnel in the event of an emergency such that personal information is held secure yet readily found by such responders.

2. The invention as defined in claim 1 wherein one or more alert decals are so designed and located in windows or externally so responders can readily notice them and read where the personal emergency information can be found.

3. The invention as defined in claim 1 wherein a caduceus or other well-recognized medical symbol is prominently displayed on the alert decal.

4. The invention as defined in claim 1 wherein an additional decal or sticker is located in a secure area of the enclosure

5. The invention as defined in claim 4 where the enclosure is a vehicle. And the secure area of enclosure is the passenger/driver compartment of the vehicle.

6. The invention as defined in claim 4 where the enclosure is a fixed building.

7. The invention as defined in claim 5 where the additional decal or sticker is located on or about the windshield visor.

8. The invention as defined in claim 4 where the additional decal or sticker may have a protective shield or sleeve to prevent unauthorized viewing.

9. The invention as defined in claim 1 where personal emergency information can include identification, written descriptions, photographs, optically stored data, holograms, electronically stored data, and magnetically stored data for one or more persons. The information storage can be amended as needed.

10. The invention as defined in claim 1 wherein the decals or stickers may be removable, semi-permanent, or permanent.
